(19) United States
(12) Patent Application Publication
(10) Pub. No.: US 2022/0381230 A1
(43) Pub. Date: Dec. 1, 2022

(54) Hydrostatic kinetic energy recovery system

(71) Applicant: Kourosh R. Ghadimi, Los Alamitos, CA (US)

(72) Inventor: Kourosh R. Ghadimi, Los Alamitos, CA (US)

(21) Appl. No.: 17/300,363

(22) Filed: Jun. 1, 2021

(51) Int. Cl. F03G 7/04

(52) U.S. Cl. CPC F03G 7/04

(57) ABSTRACT

A Hydrostatic Kinetic Energy Recovery System in this present arrangement employs a chain of pressure recovery capsules that are driven down a buried in the ground U shape pipe filled with water. At the present arrangement's depth of 80 feet, water pressure at bottom is 43 PSI which the capsule that includes a one way valve captures at that depth. The capsules are then pulled out via a wheel which houses a number of receiving modules where the captured pressure in the capsules is released through a turbine which is coupled with a generator, thus creating electricity via recovering kinetic energy of column of water.

### BACKGROUND

Every renewable energy innovation in the recent decades have some major drawbacks. Wind turbines are expensive, difficult to maintain as they are installed in remote areas, and beyond that, it is useless with low wind or no wind.

Solar and photovoltaic entirely depend on abundant sun light which is non existent half the day and very low half the year.

Hydro-Electric generation is limited to available rivers that can accommodate a dam, extremely expensive to maintain due to high cost of sediment removal.

Fossil fuel is now number one cause of climate change due to human activities.

Nuclear energy though most reliable, is dangerous and there are still no viable solution to dispose nuclear wastes properly.

The Hydrostatic Kinetic Energy Recovery System introduced here uses the abundant force of gravity and converts the hidden kinetic energy in static state of a column of water into a dynamic motion of rotating a turbine that turns a generator thus producing electricity indefinitely.

The start up cost can dramatically decrease once it enters mass production stage.

Cost of maintenance is literally forgivable as each individual part that may break down due to natural wear and tear can be easily and quickly exchanged. Once mass produced, these parts are so inexpensive that are almost hard to add to overall cost of operation.

This machine operates at any climate, anywhere on the planet, day or night, rain or shine and it never requires anything from outside world such as fuel, sun light, wind, running river water or radio active elements.

### BRIEF DESCRIPTION

The present Hydrostatic Kinetic Energy Recovery System includes a series of capsules connected to each other via chains in a single file, a rotating wheel that houses 8 receiving modules in present arrangement, each having a seal upon mating orifice, a trigger pin and a turbine that is mechanically coupled with a generator. The system is installed directly above a U shape pipe with a diameter larger than the widest part of capsules buried in the ground to reach a depth of 80 feet below surface, filled with water, open only at the top ends, allowing the capsules to enter at one end and exit from the other end, where capsules continuously move down one end and up the other end, inside the U shape pipe. The wheel, driven by a small motor, moves capsules to reach the bottom of the column of standing still water in the U shape pipe. Each capsule has two separate and different types of one way valves, one normal spring action check valve and the other a special one way valve with a triggering mechanism to open the valve once triggered, to allow water to be released. A spring keeps this valve normally closed, but lets the water under pressure in. The capsules at the bottom of the column of water capture maximum pressure, approximately 43 PSI in present arrangement and hold the pressure within since the one way valves do not allow the pressure to be released. Once at the surface and on the wheel, trigger pin of the corresponding module activates the special valve's triggering mechanism which opens the valve allowing water under pressure inside the capsule to be released into the temporarily sealed orifice on corresponding module. Once the special valve opens, water under pressure is released into and turns the turbine attached to the orifice. Said turbine is mechanically coupled with a generator which upon turning generates electricity. Since water can not be compressed, capsules partially contain air which allows the pressure to mount.

At the surface, capsules are held on the wheel with the valves facing down, keeping the compressed air above the water. Upon opening the special valve at the right moment, compressed air pushes the excess water collected at the bottom of U shape pipe out, turning the turbine.

Air in the capsules always remain locked inside and only a pre determined amount of water allowed to go in at certain depth, comes out at the surface once the special valve is opened.

The water released from the capsules through the turbine will be guided to freely return to the U shape pipe to repeat the process.

### DETAILED DESCRIPTION

Hydrostatic Kinetic Energy Recovery System introduced in this present form uses static energy in water due to gravity as a force to rotate a turbine.

It must be noted that this is not a perpetual motion machine that creates energy from nothing. This machine literally converts one form of energy to another form.

Namely force of gravity into electricity at the end of a particular cycle.

That cycle being:

Capturing a higher pressure of water at a depth relatively far bellow the surface, which in the present arrangement is 80 feet, where that pressure is 43 PSI that is to be released once brought up to surface from depth.

It also must be noted that the amount of energy produced due to pressure captured in depth and released at surface is far greater than the amount of energy needed to operate the machine which is far lower than the total energy recovered.

In the present arrangement, the Hydrostatic Kinetic Energy recovery System produces nearly 50 watts of electricity where roughly 12 watts is used in a single motor to turn the wheel that operates the entire system as the capsules pulled out of the tube weigh slightly more than the capsules that are immersed into the tube. This is due to air inside the capsule being compressed to make space for water entering under pressure at depth of 80 feet. This maintains a relatively balanced two sides in the chain of capsules entering and exiting the tube.

In this present arrangement, 200 capsules are chained together in a single file, of which no more than 7 at any given time are out of the tube and the rest are freely floating down and up in the tube. Only a portion of the volume inside each capsule is used to displace water.

The weight of each capsule is carefully calculated to minimize the force necessary to counterbalance the chain of capsules, maintaining a minimum amount of air under pressure without compromising efficiency of electrical generation in capsules pulled up to surface while portion of volume is water and rest is air as each capsule immersed back into the tube on the opposite side.

The reason for maintaining presence of air in the capsules is that water can not be compressed, but air can. Air inside the capsule is greatly reduced in volume under pressure, allowing the same volume of water to enter and remain inside through the one way valves installed next to each other on the side of capsule.

At any given time, 3 of the 5 capsules that are resting on the wheel at the surface reach a position on the wheel where the capsule's valve pin is triggered by receiving module's trigger pin. This allows the air inside the capsule to remain above the water trapped inside. Triggering the valve pin then allows the compressed air to push the water out of the nuzzle on capsule valve's head and into the orifice of the module on the wheel.

The orifice of the module on the wheel is designed in such a way as to fully seal around the capsule's valve head to help the compressed water under pressure to find a path of least resistance through the orifice of the module.

The water under pressure then has only one way to release which is through the orifice into the turbine which turns the generator, thus generating electricity.

The released water from the turbine is then guided back into the U shape tube for repeating the process. This will maintain minimum amount of water to be wasted and in a fully controlled environment like a clean room, the water will recycle almost indefinitely. However, a provisions may be placed to refill the water from a water source to maintain proper level of water in tube as needed since naturally evaporating and escaping water is inevitable.

Note that water in the present arrangement is only one form of fluid that is abundantly available, but other fluids for more effective or efficient process may be used as well. Also note that a very deep pool can be constructed instead of the U shape pipe or tube presented here which will allow the user to install multiple wheels in multiple rows to generate much more electricity.

### BRIEF DESCRIPTION OF DRAWINGS

Figure One is a close up image focusing on the elements of the main wheel.

Figure Two is the frontal cross section of the capsule showing the elements of the main valve.

Figure Three shows the general idea of the U shape pipe buried in the ground and how the wheel is assembled directly above it.

Figure Four is the exploded view of one alternative to the main valve shown in figure Two.

Figure Five is also one alternate option to replace the U shape pipe shown in figure Three to accommodate multiple wheels assembled on top of an 80 feet deep pool. The width and length of the pool can vary depending on the number of wheels to be installed.

### DESCRIPTION OF INDIVIDUAL ELEMENTS IN EACH FIGURE

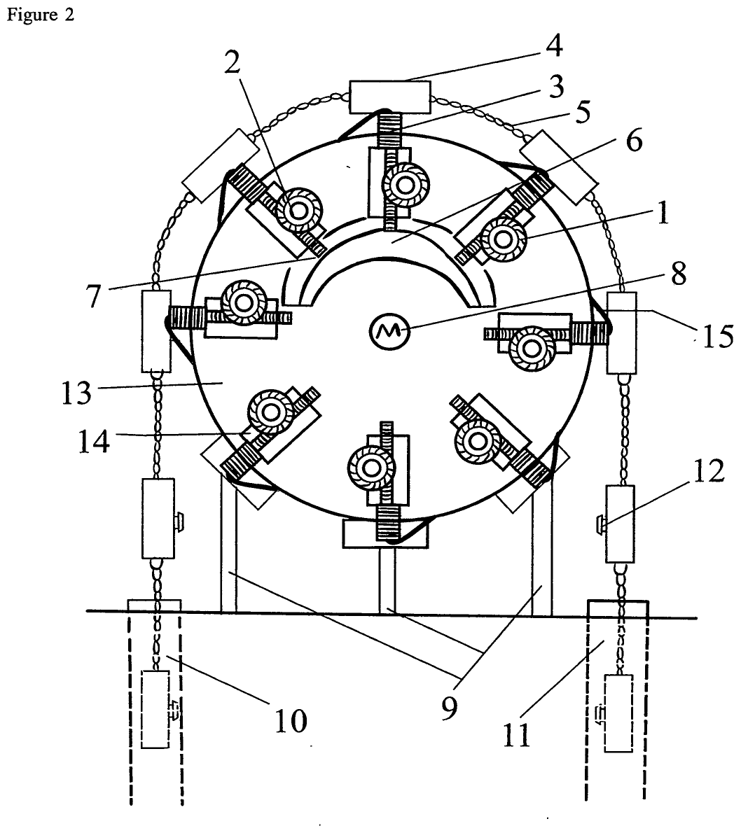

FIG. 1

1—Individual turbines. 8 total in the present arrangement.
2—Generator, mechanically coupled with each turbine.
3—Module's orifice assembly.
4—Capsule. Also known here as pressure chamber.
5—Chain connecting each capsule to adjacent ones.
6—Stationary trigger plate on wheel for activating the trigger pin on the capsule's valve.
7—Wheel's module trigger pin to activate the trigger pin of the capsule's valve once contacts to trigger plate 6.
8—Motor to turn the wheel.
9—Supports for the wheel.
10—Return side of the tube. Part of U shape pipe.
11—Capsules entrance side of the tube. Part of U shape pipe.
12—Capsule's valve assembly.

### 13—Wheel.

### 14—Modules.

15—Capsules' valve grabbing bracket with a notch.

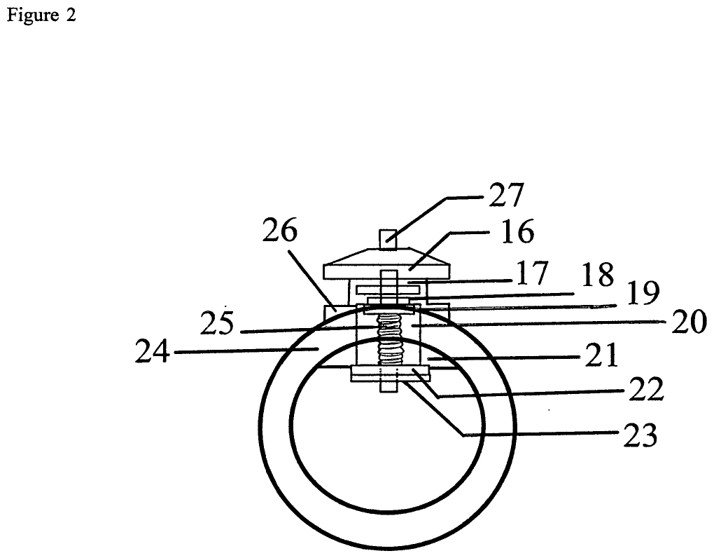

FIG. 2

16—Nozzle of valve head.
17—Valve's upper holder and guide.
18—Valve opening.

### 19—Valve.

20—Valve housing.
21—Interior filler and sealer.
22—Valve's lower holder and guide.

### 23—Nut.

24—Capsule's body.

### 25—Spring.

26—Exterior filler and sealer.
27—Valve trigger pin

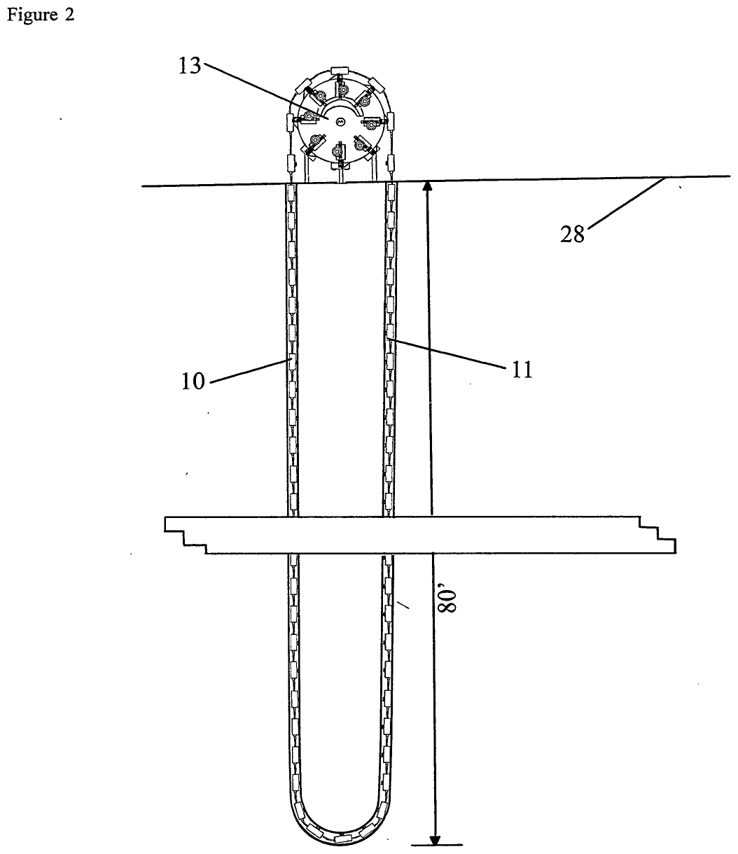

FIG. 3

10—U shape pipe, guiding capsules coming up.
11—U shape pipe, guiding capsules going down.

### 13—Wheel.

28—Ground surface.

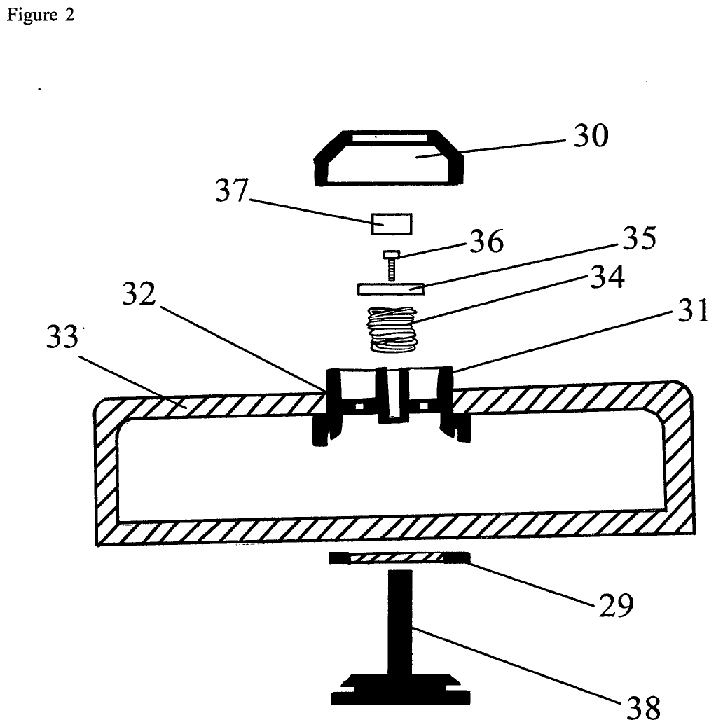

FIG. 4

### 29—Washer.

30—Nozzle or valve head.
31—Valve housing.
32—Pathway of the water.
33—Body of the capsule.

### 34—Spring.

35—Spring holder cap.
36—Spring holder cap to valve fastener.
37—Trigger point fused to spring holder cap.

### 38—Valve.

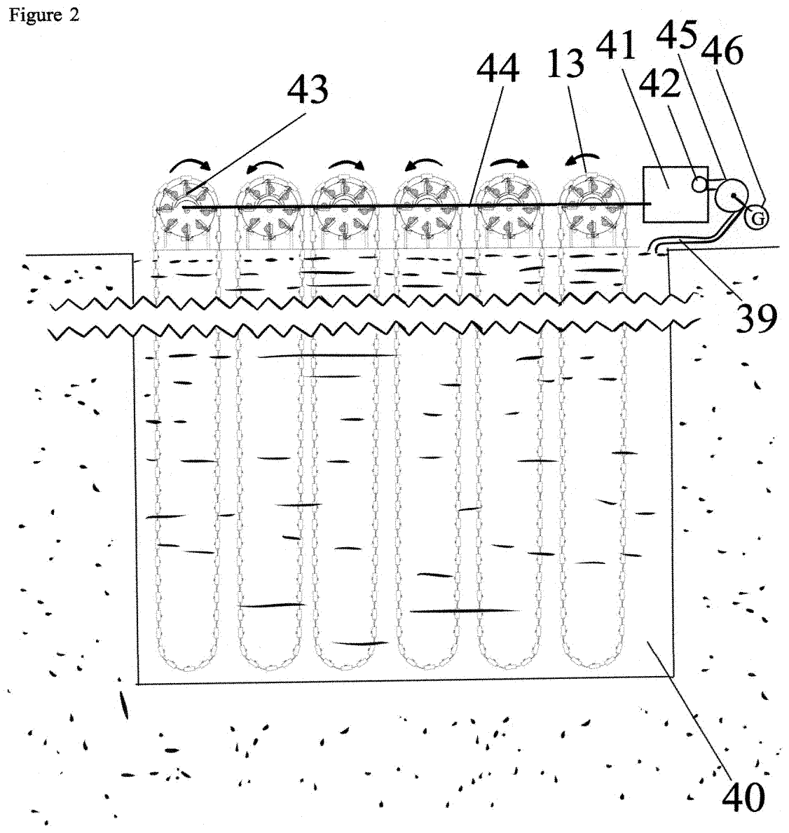

FIG. 5

13—Wheel in multiple numbers, with slightly different arrangement.
39—Water return guide.
40—Deep, fully sealed pool.
41—Equalizing chamber.
42—Pressure regulator.
43—Individual check valves.
44—Main feed line.

### 45—Turbine.

### 46—Generator.

### DETAILED DESCRIPTION OF DRAWINGS

FIG. 1

This drawing depicts the details of wheel 13. Capsule 4 coming up from pipe 10, upward portion of tube, is grabbed by its valve head by the bracket 15 on the wheel and rotates around the wheel, once the capsule 4 reaches the stationary plate 6, the plate's outward extrusion pushes the wheel's module trigger pin 7 which activates module's orifice assembly 3. This action triggers the capsule valve's assembly 12 where a pin once pushed opens the valve on capsule 4.

Opening the valve causes the water under pressure inside the capsule to release into the turbine 1, causing the turbine to turn wherein the said turbine 1 which is mechanically coupled with generator 2 thus turns it over. Turning the generator 2 then generates electricity. Once this cycle is completed, capsule 4 is guided into downward pipe 11 and the process repeats.

The entire wheel assembly resting on the supports 9 rotates via force of motor 8.

Capsule 4 is connected to adjacent capsules via chain 5.

In summary:

A tube made of durable plastic pipe, 10 and 11, in shape of letter U is installed in the ground, 80 feet deep, total of 166 feet of pipe glued together and buried in the ground, tube will be filled with water or other suitable fluids as per different designs. The specially designed wheel 13 has 8 modules 14 installed evenly across, siting on a set of supports 9 directly above the tube, pulls capsule 4 out of end 10 of tube and guides them back in on the other side of the tube 11.

Wheel 13 has bracket with grabbing notches 15 that securely hook on to the valve 12 installed on capsule 4. While holding the capsule 4, wheel 13 turns and brings each capsule to the top where they come in contact with an off axis stationary plate 6 while mating with the module's orifice 3 in order to push pin 7 out . Pin 7 is directly at the center of an orifice in the orifice assembly 3 that is by this time fully mating with the valve on the capsule's valve head 12 while sealing the contact by a rubber washer. Valve 12 on the capsule 4 has a pin extruded from its center which is part of a valve inside the capsule that is normally closed by a spring. Pushing this pin opens the valve inside the capsule which allows the water trapped inside to excrete from valve and since it is sealed by the orifice 3 of the module 14 on the wheel 13, the water has only one way to exit from the capsule which is the opening around the pin unaffected by the rubber seal.

The capsule 4 traps the water inside while it is immersed into the tube 11 that is full of water. The pressure mounts inside the capsule as it travels downward since the valves on the capsule are only one way in. The pressure mounts inside the capsule 4 due to trapped air inside. The hydrostatic force of water column allows water to enter and compress the trapped air inside until an equilibrium is achieved inside the capsule as it is at the bottom of the tube, in this version about 43 PSI.

Mounted pressure is directly proportionate to the depth of the column of water and volume of trapped air inside according to the laws of hydrodynamics.

In the present arrangement, at the depth of 80 feet this pressure is about 43 PSI and while water becomes trapped inside the capsule 4 at that depth, capsules are transported to the surface out of pipe 10 end and is guided to the top of the wheel 13 as the wheel turns, where the compressed air pushes the water out of the capsule valve 12 into the module's orifice 3 on the wheel once the valve 12 on capsule 4 is triggered by pin 7.

The module 14 on the wheel 13 is directly connected to turbine 3 which is mechanically coupled with generator 2. Water pushed out by the trapped air inside the capsule 4 is then released at the same pressure level as inside the capsule or about 43 PSI, enough to turn the turbine 1 for roughly 1-2 seconds while the capsule valve 12 is opened by trigger pin 7. This will allow one turbine at a time to turn the turbine 1 at % 50 capacity at first then % 100 capacity at the very top of the wheel and on the way back down to % 50 at the end of the cycle on wheel 13, allowing the wheel's each individual generator 2 to produce electricity at interval but in totality a constant flow of electricity of which a small portion is used to feed motor 8 that turns the entire wheel 13.

The excess energy then becomes available for consumption.

FIG. 2

This drawing depicts a version of the valve assembly on the capsules.

Capsule body 14 has opening to allow installation of valves.

The valve housing 20 is threaded all the way on the inside which allows valve 19 held by spring 25 to freely move within the openings of valve's lower holder and guide 22, valve opening 18 and valve's upper holder and guide 17 to be screwed in.

The valve housing 20 is also threaded at the bottom to be closed by nut 23 which has opening to allow the water in and out of capsule while holding the interior filler and sealer 21 and on the outside of the capsule, threaded portion of exterior of valve housing 20 allows the nozzle of the valve to be screwed on to the valve housing 20 while holding the exterior filler and sealer 26.

Nozzle of the valve head 16 has wide enough opening that allows the water in and out of capsule while valve trigger pin 27 is activated on the wheel or at the deeper part of the U shape pipe of FIG. 3 or the deeper part of pool of FIG. 5.

A spring 25 is essential to the operation of the valve to act as one way.

The tension of spring 25 is carefully calculated as to allow the water at certain pressure easily enter the capsule while keeping the valve closed whenever the pressure mounted inside the capsule is higher than the ambient pressure.

This is the most fundamental element of the entire invention:

To keep pressure inside until the time comes when the pressure is to be released.

FIG. 3

This drawing depicts the general idea of how downward pipe 10 and upward pipe 11 of the tube or continuous U shape pipe are installed bellow the surface 28 in the ground. In the present version of the invention, it is set to be 80 feet deep into the ground to achieve just over 40 PSI of pressure in the capsules. This tube is filled with water but can also contain different fluids as a different design may call for.

Wheel described in FIG. 1 is sitting at the top directly above the tube.

Note that the diameter of the wheel is best to match the exact width of opening of the tube above the ground for minimizing excess parts or slack on the chain of capsules.

There is literally no limit on how deep the tube shall extend bellow the surface where the wheel 13 is installed, however during building my prototype I discovered that if we are going bellow 100 feet which translate to above 50 PSI of pressure mounted inside the capsule, a considerable pressure is required to activate the trigger pin to open the valve on the capsules.

However different design, material and manufacturing process may be employed to achieve the ultimate effectiveness and efficiency of the system. Such as heavy metallic capsules, 200 to 300 feet deep tube, larger tube diameter, larger capsules or different fluids such as hydraulic fluid instead of water and so on.

FIG. 4

This drawing depicts exploded view of a less complicated or otherwise just another version of the main valve on the capsules.

In this version the body 33 of the capsule, the valve housing 31 and pathway of the water 32 as well as valve guide are all one single piece which can be easily molded in plastic. Valve 38 has a notch for washer 29 to help seal the valve when it is closed. Spring 34 has enough tension to keep the valve closed but is just enough to allow the water under pressure to enter the capsule, metallic spring holder cap 35 is fastened to valve 38 via screw 36.

Triggering point 37 made of same metallic materials as the spring holder cap 35 is fused to cap after screw 36 is installed which extrudes beyond the opening of nozzle or valve head 30 to be triggered by the trigger pin of the module on the wheel of FIG. 1. The same process as the other valve will repeat.

FIG. 5

This is a different version of present invention.

In this version, multiple wheels similar to the wheel shown in FIG. 1, arranged in multiple rows and multiple columns are set up in such a way that they all compliment each other, in that they all push high pressure water in capsule captured at the bottom of the pool 40 via series of check valves 43 through main feed line 44 into equalizing chamber 41, in a predetermined sequence. Water under pressure inside chamber 41 is then released through pressure regulator 42 which is connected to turbine 45.

Turbine 45 is mechanically coupled with a massive generator 46 that generates either AC or DC electricity whichever a design calls for. If AC voltage is called for, the volume of water released through pressure regulator 42 can be adjusted for a perfect frequency such as exact 60 Hertz standard AC in USA.

As in the other version, each wheel can have a small motor that turns the corresponding chain of capsules or one single motor can be employed to turn the entire row.

The pool 40 can be as deep as a design calls for depending on the pressure desired, pool may be filled with water or other suitable fluids.

The water return guide 39 then guides the water coming out of turbine 45 back into the pool 40.

What is claimed is:

1- A capsule made of plastic or other materials suitable to withhold high pressure water and air. A number of these capsules will be required and determined by the depth of water in such a way that capsules that are connected to each other via a chain can move continuously up and down from top to bottom and from bottom back to the top without a break.

2- An ordinary one way spring action check valve to be installed on the side of the capsule in claim 1.

3- A specially designed one way valve with a trigger pin that allows the valve to open upon an external push on the trigger pin to be installed next to valve on claim 2 on the side of the capsule of claim 1.

4- A wheel with certain number of modules in a special arrangement to one by one grab onto and hold the special valve of claim 3 to allow the capsule of claim 1 to rest upon the wheel while turning.

5- A series of modules each including a moving push pin activated at a certain point upon turning of the wheel in claim 4, a temporary seal upon mating orifice which will seal the connection of the module to the valve of claim 3 in order for the water to only move through the opening into the turbine, a turbine that is coupled with a generator attached individually to each module.

6- a turbine mechanically coupled with a generator attached to the modules of claim 5.

7- a round pipe made of plastic or other suitable materials to hold large amount of water and is wide enough to allow free motion of capsules of claim 1 in shape of letter U, preferably buried in the ground for ultimate support to reach a depth determined by the amount of pressure desired for each design.

8- a pool of water reaching a desired depth to accommodate a number of wheels as in claim 4 to be installed on top of the pool, allowing multiple wheels and multiple capsule arrangement to operate whereupon a much higher amount of electricity is produced.

9- a special arrangement set up of multiple wheels of claim 4 to guide the pressured water from multiple wheels into a single equalizing chamber.

10- a fully sealed chamber with only one inlet and one outlet to accommodate the arrangement of claim 9, large enough to hold a predetermined volume of water under pressure.

11- a water pressure regulator connected at the outlet of the chamber of claim 10 in order to equalize pressure of water exiting the chamber.

12- A large enough turbine that can allow the volume of water exiting the chamber on claim 10 through the water pressure regulator of claim 11 in order to turn a generator.

13- A generator with suitable capacity to accommodate the turning of the turbine of claim 12 to generate electricity.

14- A series of guiding pipes or channels to return the water from the turbines of claim 6 or turbine of claim 12 to return to pipe of claim 7 or pool of claim 8 to be recycled and reused indefinitely.

15- A water level sensing valve connected to an outside source of water to keep the water level in pipe on claim 7 or pool of claim 8 always at the proper level.
